(19) United States
(12) Patent Application Publication
(10) Pub. No.: US 2016/0178847 A1
(43) Pub. Date: Jun. 23, 2016

(54) Optical Coupler, and Optical Coupling System and Optical System Including the Same

(71) Applicant: Samsung Electronics Co., Ltd., Suwon-si (KR)

(72) Inventors: Seong-Gu Kim, Pyeongtaek-si (KR); Dong-Hyun KIM, Cheonan-si (KR); Jin-Kwon BOK, Suwon-si (KR); Dong-Jae SHIN, Seoul (KR); In-Sung JOE, Seoul (KR); Kyoung-Ho HA, Seoul (KR)

(21) Appl. No.: 14/962,107

(22) Filed: Dec. 8, 2015

(30) Foreign Application Priority Data
Dec. 19, 2014 (KR) 10-2014-0184502

(51) Int. Cl. G02B 6/34; G02B 6/124; G02B 6/122

(52) U.S. Cl. CPC G02B 6/34; G02B 6/1228; G02B 6/124

(57) ABSTRACT

An optical coupler includes a tapered portion and a grating portion. The tapered portion has a width in a second direction increasing along a first direction substantially perpendicular to the second direction. The tapered portion includes first and second ends opposed to each other in the first direction. The first end has a first width, and the second end has a second width greater than the first width. The grating portion is connected to the second end of the tapered portion, and has a curvature radius greater than a distance to the first end of the tapered portion.

### CROSS-REFERENCE TO RELATED APPLICATION

This application claims priority under 35 USC §119 to Korean Patent Application No. 10-2014-0184502, filed on Dec. 19, 2014 in the Korean Intellectual Property Office (KIPO), the contents of which are herein incorporated by reference in their entirety.

### FIELD

Example embodiments relate to an optical coupler, and an optical coupling system and an optical system including the same. More particularly, example embodiments relate to a grating coupler, and an optical coupling system and an optical system including the same.

### BACKGROUND

An optical coupler may be commonly used for inputting and outputting an optical signal, and may be fabricated so that a focus of a grating may be placed at an inlet of an optical waveguide. However, when light emitted from a light source passes through an optical waveguide to reach a grating of an optical coupler, a portion of the light may be reflected toward the optical waveguide to re-enter the light source, so that the characteristics of the light source may be deteriorated.

### SUMMARY

Example embodiments provide an optical coupler having a reduced amount of light reflected toward an optical waveguide.

Example embodiments provide an optical coupling system including an optical coupler having a reduced amount of light reflected toward an optical waveguide.

Example embodiments provide an optical system including an optical coupler having a reduced amount of light reflected toward an optical waveguide.

According to example embodiments, there is provided an optical coupler. The optical coupler includes a tapered portion and a grating portion. The tapered portion has a width in a second direction increasing along a first direction substantially perpendicular to the second direction. The tapered portion includes first and second ends opposed to each other in the first direction. The first end has a first width, and the second end has a second width greater than the first width. The grating portion is connected to the second end of the tapered portion, and has a curvature radius greater than a distance to the first end of the tapered portion.

In example embodiments, the curvature radius of the grating portion may be equal to or more than about three times of the distance to the first end of the tapered portion.

In example embodiments, the curvature of the grating portion may be infinite.

In example embodiments, the grating portion may be concave toward the first end of the grating portion.

In example embodiments, the grating portion may be convex toward the first end of the grating portion.

According to example embodiments, there is provided an optical coupling system. The optical coupling system includes an optical coupler and a waveguide. The optical coupler is formed on a substrate, and includes a tapered portion and a grating portion. The tapered portion has a width in a second direction increasing along a first direction substantially perpendicular to the second direction. The tapered portion includes first and second ends opposed to each other in the first direction. The first end has a first width, and the second end has a second width greater than the first width. The grating portion is connected to the second end of the tapered portion, and has a curvature radius greater than a distance to the first end of the tapered portion. The waveguide is connected to the first end of the tapered portion.

In example embodiments, the optical waveguide may extend in the first direction.

In example embodiments, the optical waveguide may be connected to the first end of the tapered portion at a second end thereof, and connected to a light source emitting a light signal at a first end thereof opposed to the second end in the first direction.

In example embodiments, the first end of the tapered portion may have a width in the second direction substantially the same as that of the optical waveguide.

In example embodiments, the first end of the tapered portion may have a width in the second direction greater than that of the optical waveguide.

In example embodiments, the curvature radius of the grating portion may be equal to or more than about three times of the distance to the first end of the tapered portion.

In example embodiments, the curvature of the grating portion may be infinite.

In example embodiments, the grating portion may be concave toward the first end of the grating portion.

In example embodiments, the grating portion may be convex toward the first end of the grating portion.

In example embodiments, the optical coupling system may further include a cladding between the substrate and the optical coupler and between the substrate and the optical waveguide.

According to example embodiments, there is provided an optical system. The optical system includes a light source, a first waveguide, a first optical coupler, an optical fiber, and a second optical coupler. The light source is formed on a first substrate, and emits a light signal. The first waveguide is connected to the light source on the first substrate, and guides the light signal emitted from the light source. The first optical coupler is connected to the first optical waveguide on the first substrate, and emits the light signal guided by the first waveguide toward an outside. The first optical coupler includes a first tapered portion and a first grating portion. The first tapered portion includes first and second ends opposed to each other. The first and second ends have first and second widths, and the second width is greater than the first width. The first grating portion is connected to the second end of the first tapered portion, and has a curvature radius greater than a distance to the first waveguide. The light signal emitted from the first optical coupler is transferred through the optical fiber. The second optical coupler is formed on a second substrate, and includes a second grating portion into which the light signal transferred through the optical fiber is input, and a second tapered portion connected to the second grating portion.

In example embodiments, the optical system may further include a second optical waveguide connected to the second optical coupler and guiding the light signal entering the second optical coupler, and a light receiving element receiving the light signal guided by the second optical waveguide to convert it into an electrical signal.

In example embodiments, the second tapered portion may include first and second ends opposed to each other. The first and second ends may have third and fourth widths, and the fourth width may be greater than the third width. The second grating portion may be connected to the second end of the second tapered portion, and may have a curvature radius substantially the same as a distance to the second optical waveguide.

In example embodiments, the first end of the first tapered portion may have a width greater than that of the first optical waveguide.

In example embodiments, the curvature of the first grating portion may be infinite.

In the optical coupling system in accordance with example embodiments, only a very small portion of a light signal emitted from a light source may be reflected by an optical coupler to re-enter the light source, and the reflectivity or the rate of re-entering of light may decrease accordingly as a curvature radius of the optical coupler increases. Thus, the characteristics of the optical coupler may not be deteriorated by reflection. Additionally, the width of an end of the optical coupler connected to the optical waveguide may be increased so as to reduce the rate of re-entering of light.

### BRIEF DESCRIPTION OF THE DRAWINGS

Example embodiments will be more clearly understood from the following detailed description taken in conjunction with the accompanying drawings. FIGS. 1 to 25 represent non-limiting, example embodiments as described herein.

FIGS. 1 and 2 are a plan view and a cross-sectional view, respectively, illustrating a first optical coupling system in accordance with example embodiments, and FIG. 3 is a plan view illustrating a second optical coupling system in accordance with Comparative Embodiment;

FIG. 4 illustrates an optical path in the first optical coupling system in accordance with example embodiments, and FIG. 5 illustrates an optical path in the second optical coupling system in accordance with Comparative Embodiment;

FIGS. 6 and 7 illustrate third and fourth optical coupling systems in accordance with example embodiments;

FIGS. 8 and 9 illustrate optical paths in the third and fourth optical coupling systems, respectively, in accordance with example embodiments;

FIGS. 10 to 19 are plan views and cross-sectional views illustrating stages of a method of manufacturing a first optical coupling system in accordance with example embodiments;

FIG. 20 is a plan view illustrating a fifth optical coupling system in accordance with example embodiments;

FIG. 21 illustrates an optical path in the fifth optical coupling system in accordance with example embodiments;

FIGS. 22 and 23 are plan views illustrating sixth and seventh optical coupling systems in accordance with example embodiments; and

FIGS. 24 and 25 illustrate an optical system in accordance with example embodiments.

### DESCRIPTION OF EMBODIMENTS

Various example embodiments will be described more fully hereinafter with reference to the accompanying drawings, in which some example embodiments are shown. The present inventive concept may, however, be embodied in many different forms and should not be construed as limited to the example embodiments set forth herein. Rather, these example embodiments are provided so that this description will be thorough and complete, and will fully convey the scope of the present inventive concept to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, fourth etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present inventive concept.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

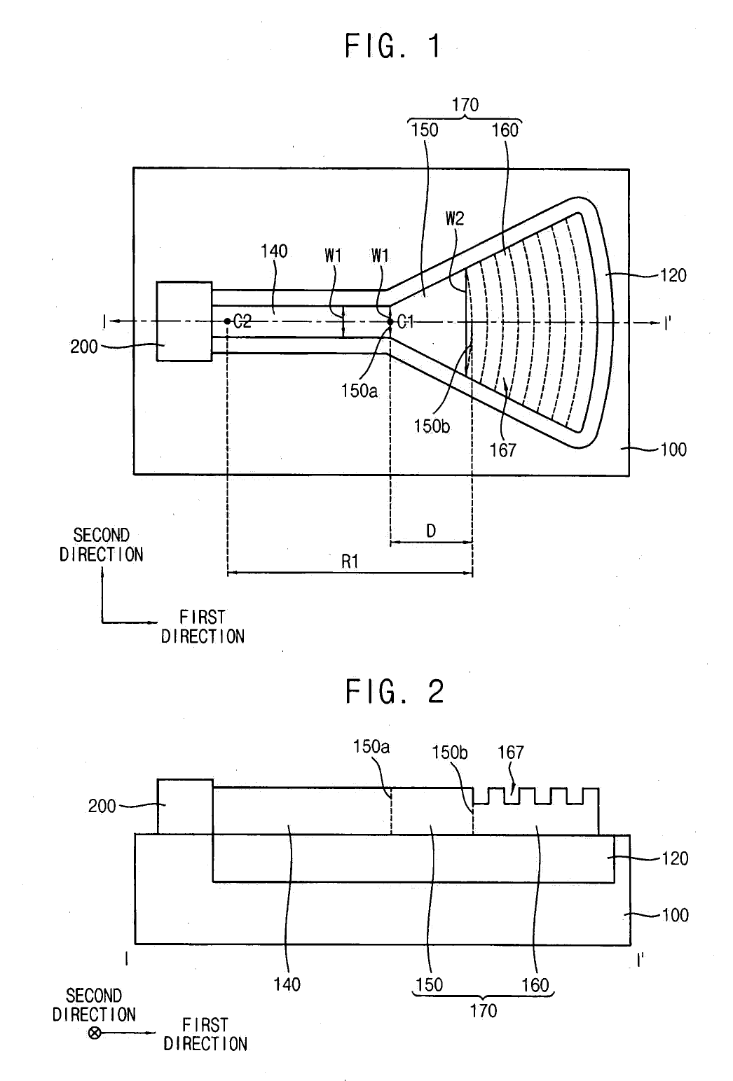

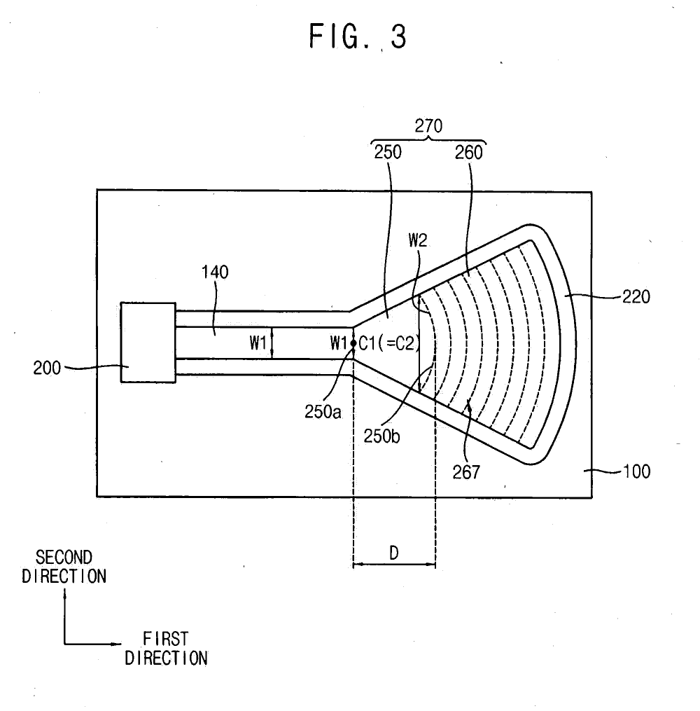

FIGS. 1 and 2 are a plan view and a cross-sectional view, respectively, illustrating a first optical coupling system in accordance with example embodiments, and FIG. 3 is a plan view illustrating a second optical coupling system in accordance with Comparative Embodiment. FIG. 2 is a cross-sectional view taken along a line I-I′ of FIG. 1.

Referring to FIGS. 1 and 2, the first optical coupling system may include a first optical waveguide 140 and a first optical coupler 170 on a first substrate 100.

The first substrate 100 may be a semiconductor substrate, e.g., a silicon substrate, a germanium substrate, a silicon-germanium substrate, etc. Alternatively, the first substrate 100 may be a silicon-on-insulator (SOI) substrate or a germanium-on-insulator (GOI) substrate.

The first optical waveguide 140 may be formed on the first substrate 100 to be connected to a light source 200 emitting a light signal, and may guide a light signal emitted from the light source 200 toward a specific direction.

The light source 200 may be a laser diode (LD) generating a laser beam to emit it toward an outside, however, the present inventive concept may not be limited thereto, and the light source 200 may generate and emit various other types of lights.

In example embodiments, the first optical waveguide 140 may extend in a first direction substantially parallel to a top surface of the first substrate 100, and have a first width W1 in a second direction substantially parallel to the top surface of the substrate 100 and substantially perpendicular to the first direction. Thus, the first optical waveguide 140 may guide the light signal emitted from the light source 200 into the first direction. In an example embodiment, the first width W1 may be constant along the first direction, and thus the first optical waveguide 140 may have a bar shape extending in the first direction.

The first optical waveguide 140 may include, e.g., polysilicon or single crystalline silicon.

The first optical coupler 170 may be formed on the first substrate 100 to be connected to the first optical waveguide 140, and may emit the light signal guided by the first optical waveguide 140 toward an outside.

The first optical coupler 170 may include a first tapered portion 150 and a first grating portion 160.

The first tapered portion 150 may be connected to the first optical waveguide 140 at a first end 150a thereof in the first direction. In example embodiments, the first tapered portion 150 may have a fan-like shape, and a width thereof in the second direction may increase along the first direction. In example embodiments, the first tapered portion 150 may have the first width W1 in the second direction, which may be the same as that of the first optical waveguide 140, at the first end 150a, and may have a second width W2 in the second direction, which may be greater than the first width W1, at a second end 150b opposed to the first end 150a in the first direction. The first end 150a of the first tapered portion 150 may have a linear bar shape extending in the second direction, and the second end 150b of the first tapered portion 150 may have a shape of a portion of a circle, i.e., an arc shape. The arc shape of the second end 150b of the first tapered portion 150 may be substantially the same as that of first grooves 167 of the first grating portion 160.

The first grating portion 160 may be connected to the second end 150b of the first tapered portion 150. In example embodiments, the first grating portion 160 may have a fan-like shape, and a width thereof in the second direction may increase along the first direction. Thus, a first end of the first grating portion 160 connected to the first tapered portion 150 may have the second width W2 in the second direction, which may be the same as that of the second end 150b of the first tapered portion 150, and a second end of the first grating portion 160 opposed to the first end thereof in the first direction may have a width greater than the second width W2. In example embodiments, a rate of increase in width of the first grating portion 160 along the first direction may be substantially the same as that of the first tapered portion 150 along the first direction.

The first grating portion 160 may include a plurality of first grooves 167 in the second direction thereon. In example embodiments, each of the first grooves 167 may have a shape of a portion of concentric circles, i.e., an arc shape, and a center of the concentric circles may be located on a line passing a first center point C1, which is a center point of the first end 150a of the first tapered portion 150 in the second direction, and extending in the first direction. Hereinafter, the center of the concentric circles may be referred to as a second center point C2. In example embodiments, the second center point C2 may be located in the first optical waveguide 140 or in the light source 200. Alternatively, the second center point C2 may be located on the first substrate 100 away from the light source 200, or at other positions away from the first substrate 100.

A distance from each of the first grooves 167 to the second center point C2 may be referred to as a first curvature radius R1, and FIG. 1 shows the first curvature radius R1 of a nearest one of the first grooves 167 to the first tapered portion 150. In example embodiments, the first curvature radius R1 of each of the first grooves 167 of the first grating portion 160 may be greater than a distance D from each of the first grooves 167 to the first end 150a of the first tapered portion 150, i.e., a distance from each of the first grooves 167 to the first optical waveguide 140. In an example embodiment, the first curvature radius R1 may be equal to or more than about three times of the distance D.

The first tapered portion 150 and the first grating portion 160 may include, e.g., polysilicon or single crystalline silicon. In example embodiments, the first optical waveguide 140 and the first optical coupler 170 may include substantially the same material, and thus may be formed integrally.

A first cladding 120 may be formed between the first substrate 100 and the first optical waveguide 140 and between the first substrate 100 and the first optical coupler 170. In a plan view, the first cladding 120 may have an area greater than those of the first optical waveguide 140 and the first optical coupler 170 so as to surround them. The first cladding 120 may include an oxide, e.g., silicon oxide, and thus may have a refractive index less than that of each of the first optical waveguide 140 and the first optical coupler 170.

The second optical coupling system in accordance with Comparative Embodiment may be substantially the same as or similar to the first optical coupling system illustrated with reference to FIGS. 1 and 2, except for the shapes of the optical coupler and the corresponding cladding. Thus, like reference numerals refer to like elements, and detailed descriptions thereon are omitted herein.

Referring to FIG. 3, the second optical system in accordance with Comparative Embodiment may include the first optical waveguide 140 and a second optical coupler 270 on the first substrate 100.

The second optical coupler 270 may include a second tapered portion 250 and a second grating portion 260.

The second tapered portion 250 may be connected to the first optical waveguide 140 at a first end 250a thereof in the first direction. In example embodiments, the second tapered portion 250 may have a fan-like shape, and a width thereof in the second direction may increase along the first direction. The first end 250a of the second tapered portion 250 may have a linear bar shape extending in the second direction, and a second end 250b of the second tapered portion 250 opposed to the first end 250a thereof in the first direction may have a shape of a portion of a circle, i.e., an arc shape. The arc shape of the second end 250b of the second tapered portion 250 may be substantially the same as that of second grooves 267 of the second grating portion 260.

The second grating portion 260 may be connected to the second end 250b of the second tapered portion 250. In example embodiments, the second grating portion 260 may have a fan-like shape, and a width thereof in the second direction may increase along the first direction. In example embodiments, a rate of increase in width of the second grating portion 260 along the first direction may be substantially the same as that of the second tapered portion 250 along the first direction.

The second grating portion 260 may include a plurality of second grooves 267 in the second direction thereon. In example embodiments, each of the second grooves 167 may have a shape of a portion of concentric circles, i.e., an arc shape, and a center of the concentric circles, i.e., a second center point C2 may be located on a first center point C1, which is a center point of the first end 250a of the second tapered portion 250 in the second direction. That is, the first and second center points C1 and C2 may be located at substantially the same position.

A distance from each of the second grooves 267 to the second center point C2 may be referred to as a second curvature radius R2, and FIG. 3 shows the second curvature radius R2 of a nearest one of the second grooves 267 to the second tapered portion 250. In example embodiments, the second curvature radius R2 of each of the second grooves 267 of the second grating portion 260 may be substantially the same as a distance D from each of the second grooves 267 to the first end 250a of the second tapered portion 250, i.e., a distance from each of the second grooves 267 to the first optical waveguide 140.

In a plan view, a second cladding 220, which may be formed between the first substrate 100 and the first optical waveguide 140 and between the first substrate 100 and the second optical coupler 270, may have an area greater than those of the first optical waveguide 140 and the second optical coupler 270 so as to surround them.

Hereinafter, a degree to which a light signal reflects by the optical coupler toward the optical waveguide will be illustrated both in example embodiments and Comparative Embodiment.

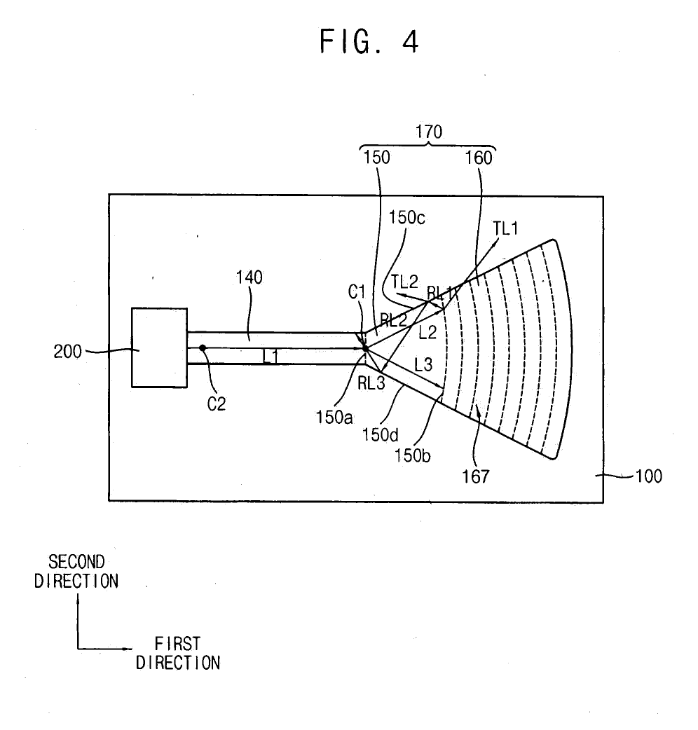

FIG. 4 illustrates an optical path in the first optical coupling system in accordance with example embodiments, and FIG. 5 illustrates an optical path in the second optical coupling system in accordance with Comparative Embodiment.

Referring to FIG. 5, a light signal generated and emitted from the light source 200, e.g., a first laser beam L1 may be guided by the first optical waveguide 140 into the first direction to enter the second optical coupler 270. The first laser beam L1 may be divided into a plurality of laser beams in the second tapered portion 250 of the second optical coupler 270, and second and third laser beams L2 and L3 among the plurality of laser beams are illustrated in FIG. 5.

For the convenience of explanation, only the second laser beam L2 will be explained hereinafter. A portion of the second laser beam L2, which may start from the first center point C1 located at a center of the first end 250a of the second tapered portion 250 in the second direction to enter the second grating portion 260, may penetrate through the second grating portion 260 by diffraction to be emitted toward an outside as a first penetration beam TL1, and another portion of the second laser beam L2 may be reflected at the second end 250b of the second tapered portion 250 to become a first reflection beam RL1. The second center point C2, which may be a center of concentric circles formed by the second grooves 267 of the second grating portion 260, may be located at a position substantially the same as that of the first center point C1, and thus most of the first reflection beam RL1 may re-enter the first optical waveguide 140 in which the second center point C2 is located, and may be guided by the first optical waveguide 140 to re-enter the light source 200.

Accordingly, in the second optical coupling system, a portion of, e.g., about 10% to about 20% of the first laser beam L1 emitted from the light source 200 may be reflected by the second optical coupler 270 to re-enter the light source 200, which may deteriorate the characteristics and efficiency of the light source 200 and the second optical system.

However, referring to FIG. 4, a light signal generated and emitted from the light source 200, e.g., a first laser beam L1 may be guided by the first optical waveguide 140 into the first direction to enter the first optical coupler 170. The first laser beam L1 may be divided into a plurality of laser beams in the first tapered portion 150 of the first optical coupler 170, and second and third laser beams L2 and L3 among the plurality of laser beams are illustrated in FIG. 4.

For the convenience of explanation, only the second laser beam L2 will be explained hereinafter. A portion of the second laser beam L2, which may start from the first center point C1 located at a center of the first end 150a of the first tapered portion 150 in the second direction to enter the first grating portion 160, may penetrate through the first grating portion 160 by diffraction to be emitted toward an outside as a first penetration beam TL1, and another portion of the second laser beam L2 may be reflected at the second end 150b of the first tapered portion 150 to become a first reflection beam RL1.

The second center point C2, which may be a center of concentric circles formed by the first grooves 167 of the first grating portion 160, may be located at a position different from that of the first center point C1, and thus not all of the first reflection beam RL1 may be reflected toward the first center C1 according to the law of reflection, and at least a portion of the first reflection beam RL1 may be reflected toward a third end 150c of the first tapered portion 150 in the second direction.

A portion of the first reflection beam RL1 reflected toward the third end 150c of the first tapered portion 150 may be reflected toward a fourth end 150d of the first tapered portion 150 opposed to the third end 150c in the second direction to become a second reflection beam RL2, which may be reflected again to become a third reflection beam RL3 re-entering the first optical waveguide 140. However, another portion of the first reflection beam RL1 may penetrate through the third end 150c of the first tapered portion 150 toward an outside to become a second penetration beam TL2. That is, unlike the second optical coupling system, in the first optical coupling system, most of the first reflection beam RL1 may not re-enter the first center point C1, and at least a portion of the first reflection beam RL1 may penetrate through the first tapered portion 150 toward the outside.

Accordingly, in the first optical coupling system, only a very small portion of the first laser beam L1 emitted from the light source 200 may be reflected by the first optical coupler 170 to re-enter the light source 200, and the reflectivity or the rate of re-entering of light may decrease accordingly as the first curvature radius R1 increases. According to the result of experiment, for example, when the first curvature radius R1 was equal to or more than about three times of the distance D, the reflectivity or the rate of re-entering was less than about 1%.

As illustrated above, the first optical coupling system including the first optical coupler 170 may have good characteristics and efficiency not deteriorated by reflection.

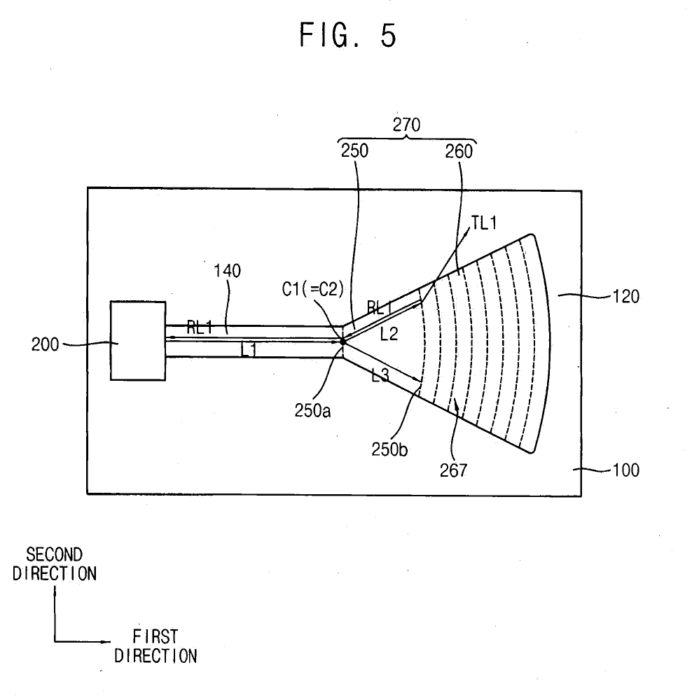

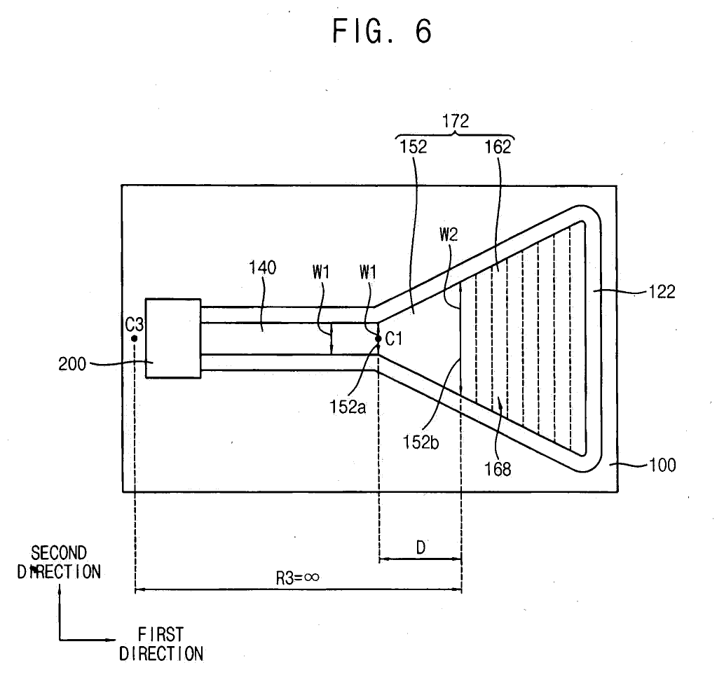

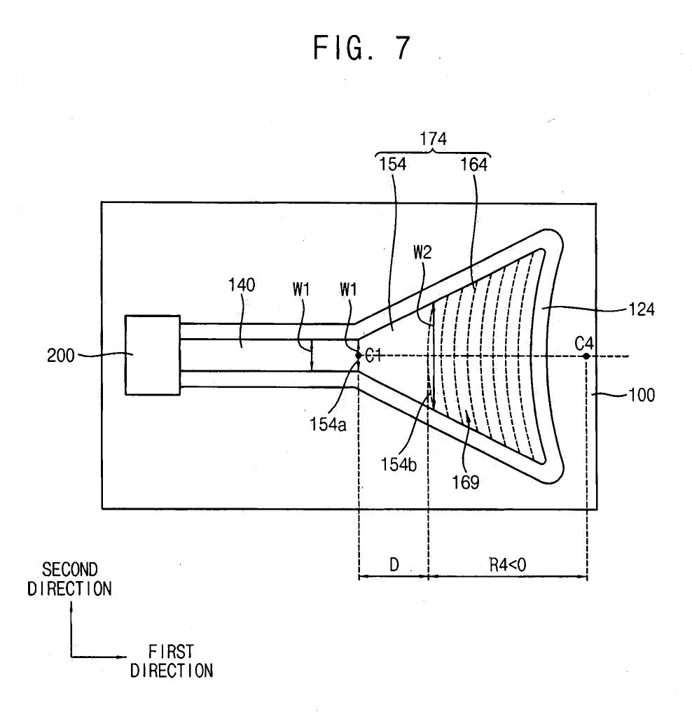

FIGS. 6 and 7 illustrate third and fourth optical coupling systems in accordance with example embodiments. The third and fourth optical coupling systems may be substantially the same as the first optical coupling system illustrated with reference to FIGS. 1 and 2, except for the shapes of the optical coupler and the corresponding cladding. Thus, like reference numerals refer to like elements, and detailed descriptions thereon are omitted herein.

Referring to FIG. 6, the third optical coupling system may include the first optical waveguide 140 and a third optical coupler 172 on the first substrate 100.

The third optical coupler 172 may include a third tapered portion 152 and a third grating portion 162.

The third tapered portion 152 may be connected to the first optical waveguide 140 at a first end 152a thereof in the first direction. In example embodiments, the third tapered portion 152 may have a fan-like shape, and a width thereof in the second direction may increase along the first direction. In example embodiments, the third tapered portion 152 may have the first width W1 in the second direction, which may be the same as that of the first optical waveguide 140, at the first end 152a, and may have the second width W2 in the second direction, which may be greater than the first width W1, at a second end 152b opposed to the first end 152a in the first direction. Each of the first and second ends 152a and 152b of the third tapered portion 152 may have a linear bar shape extending in the second direction.

The third grating portion 162 may include a plurality of third grooves 168 in the second direction thereon. In example embodiments, each of the third grooves 168 may have a linear bar shape extending in the second direction. Thus, when compared to each of the first grooves 167 of the first grating portion 160 having the shape of a portion of concentric circles with the first curvature radius R1, i.e., an arc shape, each of the third grooves 168 of the third grating portion 162 may have a shape of a portion of concentric circles with a third curvature radius R3, which may be infinite. A third center point C3, which may be a center of the concentric circles with the infinite third curvature radius R3 may be located at a position much farther than the first center point C1 from the third grooves 168 in the first direction.

Accordingly, the third curvature radius R3 of each of the third grooves 168 of the third grating portion 162 may be much greater than a distance D from each of the third grooves 168 to the first end 152a of the third tapered portion 152, i.e., a distance from each of the third grooves 168 to the first optical waveguide 140.

In a plan view, a third cladding 122, which may be formed between the first substrate 100 and the first optical waveguide 140 and between the first optical waveguide 140 and the third optical coupler 172, may have an area greater than those of the first optical waveguide 140 and the third optical coupler 172 so as to surround them.

Referring to FIG. 7, the fourth optical coupling system may include the first optical waveguide 140 and a fourth optical coupler 174 on the first substrate 100.

The fourth optical coupler 174 may include a fourth tapered portion 154 and a fourth grating portion 164.

The fourth tapered portion 154 may be connected to the first optical waveguide 140 at a first end 154a thereof in the first direction. In example embodiments, the fourth tapered portion 154 may have a fan-like shape, and a width thereof in the second direction may increase along the first direction. In example embodiments, the fourth tapered portion 154 may have the first width W1 in the second direction, which may be the same as that of the first optical waveguide 140, at the first end 154a, and may have the second width W2 in the second direction, which may be greater than the first width W1, at a second end 154b opposed to the first end 154a in the first direction. The first end 154a of the fourth tapered portion 154 may have a linear bar shape extending in the second direction, and the second end 154b of the fourth tapered portion 154 may have a shape of a portion of a circle, i.e., an arc shape.

When compared to the second end 150b of the first tapered portion 150 having an arc shape concave toward the first end 150a of the first tapered portion 150, the second end 154b of the fourth tapered portion 154 may have an arc shape convex toward the first end 154a of the fourth tapered portion 154. The convex arc shape of the second end 154b of the fourth tapered portion 154 may be substantially the same as that of fourth grooves 169 of the fourth grating portion 164.

The fourth grating portion 164 may be connected to the second end 154b of the fourth tapered portion 154, and a width thereof in the second direction may increase along the first direction. In example embodiments, a rate of increase in width of the fourth grating portion 164 along the first direction may be substantially the same as that of the fourth tapered portion 154 along the first direction.

The fourth grating portion 164 may include a plurality of fourth grooves 169 in the second direction thereon. In example embodiments, each of the fourth grooves 169 of the fourth grating portion 164 may have a shape of a portion of concentric circles, i.e., an arc shape, and a center of the concentric circles may be located on a line passing a first center point C1, which is a center point of the first end 154a of the fourth tapered portion 154 in the second direction, and extending in the first direction. Hereinafter, the center of the concentric circles may be referred to as a fourth center point C4. In example embodiments, the fourth center point C4 may be located in the fourth grating portion 164 or in the fourth cladding 124. Alternatively, the fourth center point C4 may be formed away from the fourth grating portion 164 in the first direction on the first substrate 100, or at other positions away from the first substrate 100, if only the fourth center point C4 is located to be opposite to the first center point C1 with respect to the second end 154b of the fourth tapered portion 154.

A distance from each of the fourth grooves 169 to the fourth center point C4 may be referred to as a fourth curvature radius R4. In example embodiments, the fourth curvature radius R4 of each of the fourth grooves 169 of the fourth grating portion 164 may be identical to or different from a distance D from each of the fourth grooves 169 to the first end 154a of the fourth tapered portion 154, i.e., the distance D from each of the fourth grooves 169 to the first optical waveguide 140. However, the fourth center point C4 may be located to be opposite to the first center point C1 with respect to the second end 154b of the fourth tapered portion 154, and thus it may be appreciated that the fourth curvature radius R4 may have a negative value.

In a plan view, a fourth cladding 124, which may be formed between the first substrate 100 and the first optical waveguide 140 and between the first optical waveguide 140 and the fourth optical coupler 174, may have an area greater than those of the first optical waveguide 140 and the fourth optical coupler 174 so as to surround them.

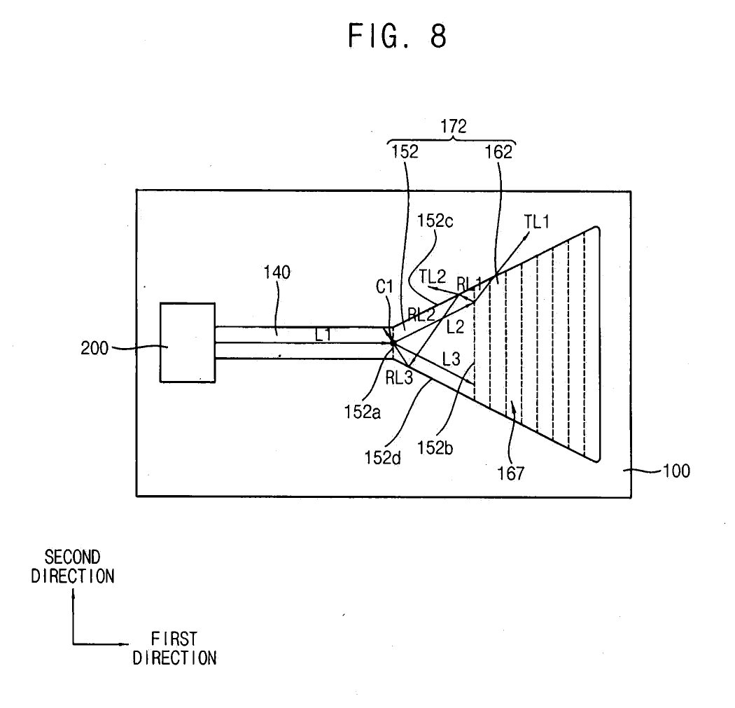

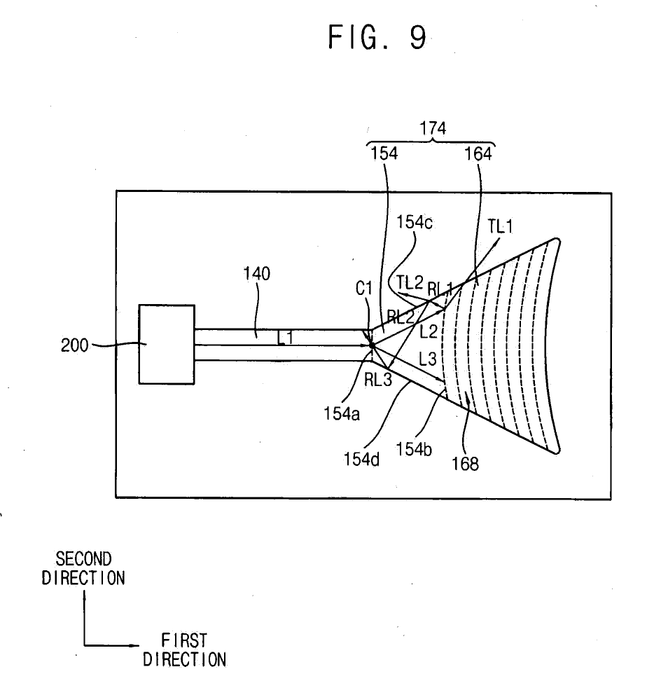

FIGS. 8 and 9 illustrate optical paths in the third and fourth optical coupling systems, respectively, in accordance with example embodiments.

Referring to FIG. 8, a light signal generated and emitted from the light source 200, e.g., a first laser beam L1 may be guided by the first optical waveguide 140 into the first direction to enter the third optical coupler 172. The first laser beam L1 may be divided into a plurality of laser beams in the third tapered portion 152 of the third optical coupler 172, and second and third laser beams L2 and L3 among the plurality of laser beams are illustrated in FIG. 8.

For the convenience of explanation, only the second laser beam L2 will be explained hereinafter. A portion of the second laser beam L2, which may start from the first center point C1 to enter the third grating portion 162, may penetrate through the third grating portion 162 by diffraction to be emitted toward an outside as a first penetration beam TL1, and another portion of the second laser beam L2 may be reflected at the second end 152b of the third tapered portion 152 to become a first reflection beam RL1. According to the law of reflection, the first reflection beam RL1 may propagate toward the third end 152c of the third tapered portion 152.

A portion of the first reflection beam RL1 reflected toward the third end 152c of the third tapered portion 152 may be reflected toward the fourth end 152d opposed to the third end 152c of the third tapered portion 152 in the second direction to become a second reflection beam RL2, which may be reflected again to become a third reflection beam RL3 re-entering the first optical waveguide 140. However, another portion of the first reflection beam RL1 may penetrate through the third end 152c of the third tapered portion 152 toward an outside to become a second penetration beam TL2.

Accordingly, in the third optical coupling system, a portion of, e.g., less than about 1% of the first laser beam L1 emitted from the light source 200 may be reflected by the third optical coupler 172 to re-enter the light source 200, and thus the third optical coupling system including the third optical coupler 172 may have good characteristics and efficiency not deteriorated by reflection.

Referring to FIG. 9, like the first optical coupling system illustrated with reference to FIG. 4, in the fourth coupling system, only a very small portion of a first laser beam L1 emitted from the light source 200 may be reflected by the fourth optical coupler 174 to re-enter the light source 200, and thus the fourth optical coupling system may have good characteristics and efficiency not deteriorated by reflection.

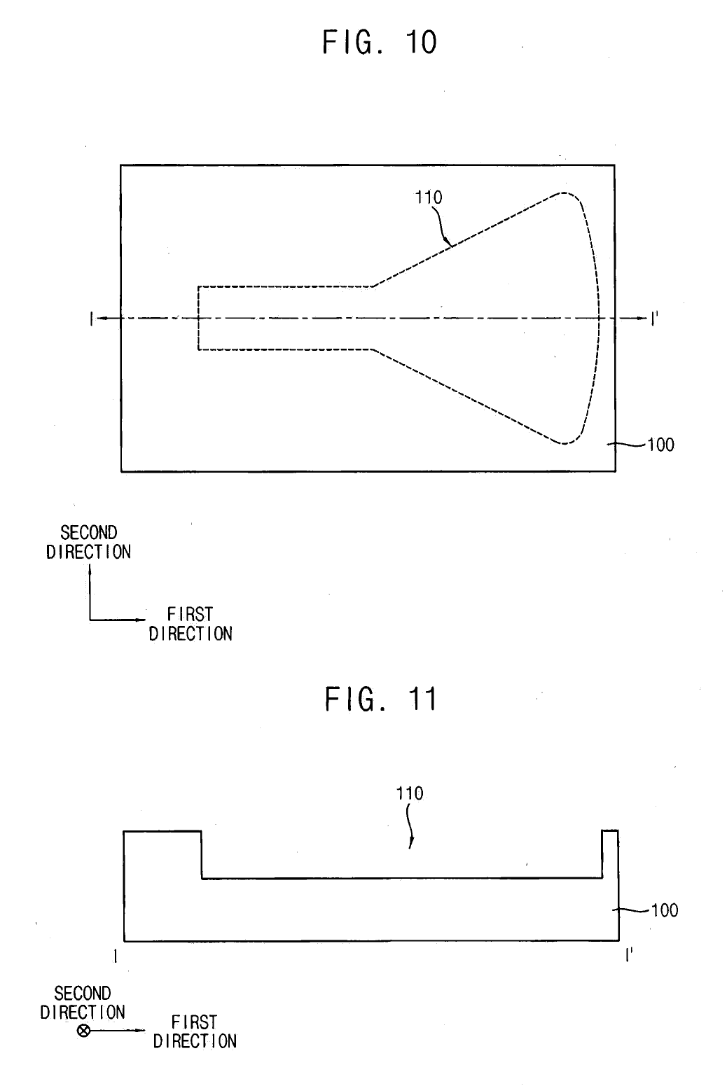

FIGS. 10 to 19 are plan views and cross-sectional views illustrating stages of a method of manufacturing a first optical coupling system in accordance with example embodiments. Particularly, FIGS. 10, 12, 14, 16 and 18 are plan views, and FIGS. 11, 13, 15, 17 and 19 are cross-sectional views taken along a line I-I′ of corresponding plan views.

Referring to FIGS. 10 and 11, a trench 110 may be formed on a first substrate 100.

The first substrate 100 may be a semiconductor substrate, e.g., a silicon substrate, a germanium substrate, a silicon-germanium substrate, etc. Alternatively, the first substrate 100 may be an SOI substrate or a GOI substrate.

In example embodiments, the trench 110 may be formed by a dry etching process using a first photoresist pattern (not shown) as an etching mask. In example embodiments, the trench 110 may be formed to have a bar shape extending in a first direction substantially parallel to a top surface of the first substrate 100, and a fan-like shape connected to the bar shape and having a width in a second direction substantially parallel to the top surface of the first substrate 100 and substantially perpendicular to the first direction increasing along the first direction.

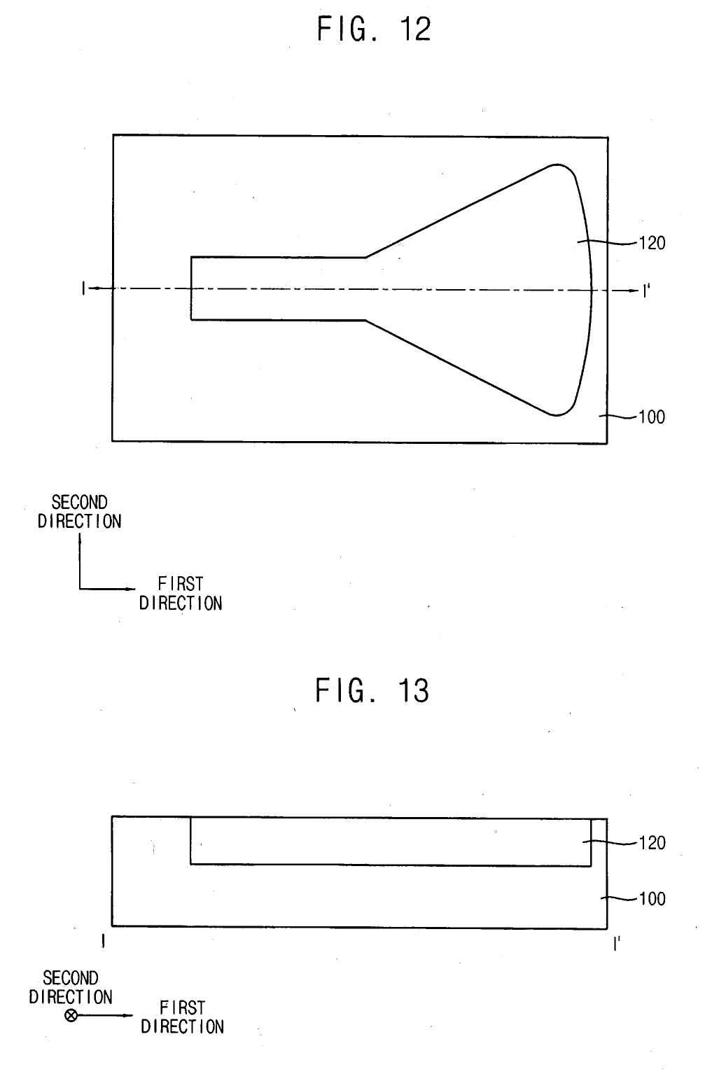

Referring to FIGS. 12 and 13, a first cladding 120 may be formed on the first substrate 100 to fill the trench 110.

In example embodiments, an insulation layer may be formed on the first substrate 100 to sufficiently fill the trench 110, and planarized until a top surface of the first substrate 100 may be exposed to form the first cladding 120. According to the shape of the trench 110, the first cladding 120 may be formed to have a bar shape extending in the first direction, and a fan-like shape connected to the bar shape and having a width in the second direction increasing along the first direction.

The insulation layer may be formed using, e.g., silicon oxide by a chemical vapor deposition (CVD) process, an atomic layer deposition (ALD) process, a physical vapor deposition (PVD) process, etc. The planarization process may be performed by a chemical mechanical polishing (CMP) process and/or an etch-back process.

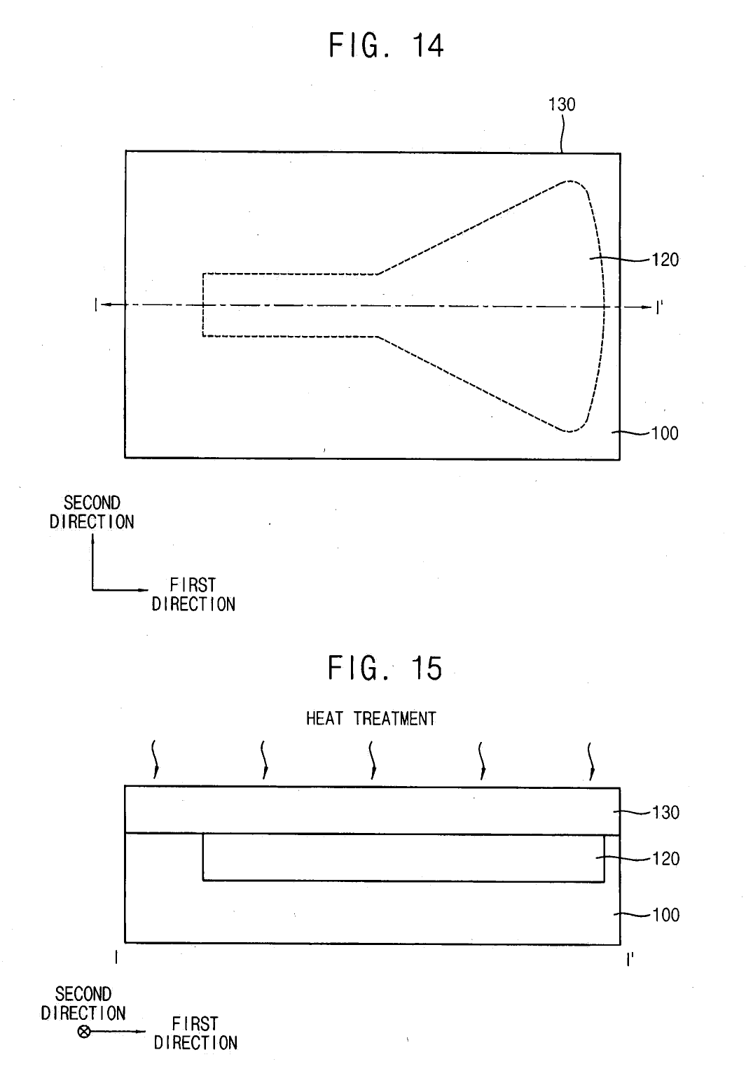

Referring to FIGS. 14 and 15, an amorphous semiconductor layer may be formed on the first cladding 120 and the first substrate 100, and may be thermally treated to form a crystalline semiconductor layer 130.

The amorphous semiconductor layer may be formed using a semiconductor material, e.g., silicon, germanium, etc., by a CVD process, an ALD process, a PVD process, etc.

The crystalline semiconductor layer 130 may be formed by performing a solid phase epitaxy (SPE) process on the amorphous semiconductor layer. Alternatively, the crystalline semiconductor layer 130 may be formed by performing a laser epitaxial growth (LEG) process on the amorphous semiconductor layer. Thus, the crystalline semiconductor layer 130 may be formed to include, e.g., polysilicon, poly-germanium, single crystalline silicon, single crystalline germanium, etc.

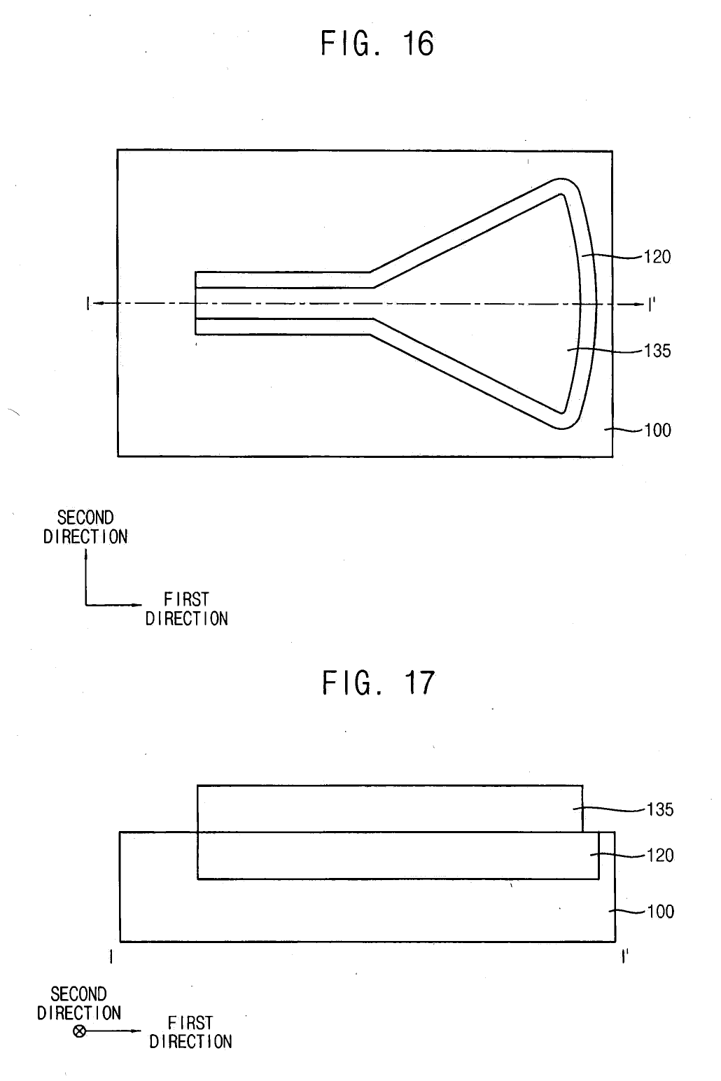

Referring to FIGS. 16 and 17, the crystalline semiconductor layer 130 may be partially etched to form a crystalline semiconductor layer pattern 135.

In example embodiments, the crystalline semiconductor layer 130 may be etched by a dry etching process using a second photoresist pattern (not shown) as an etching mask to form the crystalline semiconductor layer pattern 135 exposing at least a portion of a top edge surface of the first cladding 120. In example embodiments, the crystalline semiconductor layer pattern 135 may be formed to include a first portion having a bar shape extending in the first direction, and a second portion connected to the first portion and having a fan-like shape of which a width in the second direction may increase along the first direction. In an example embodiment, an end of the first portion of the crystalline semiconductor layer pattern 135 may vertically overlap a corresponding end of the underlying cladding 120.

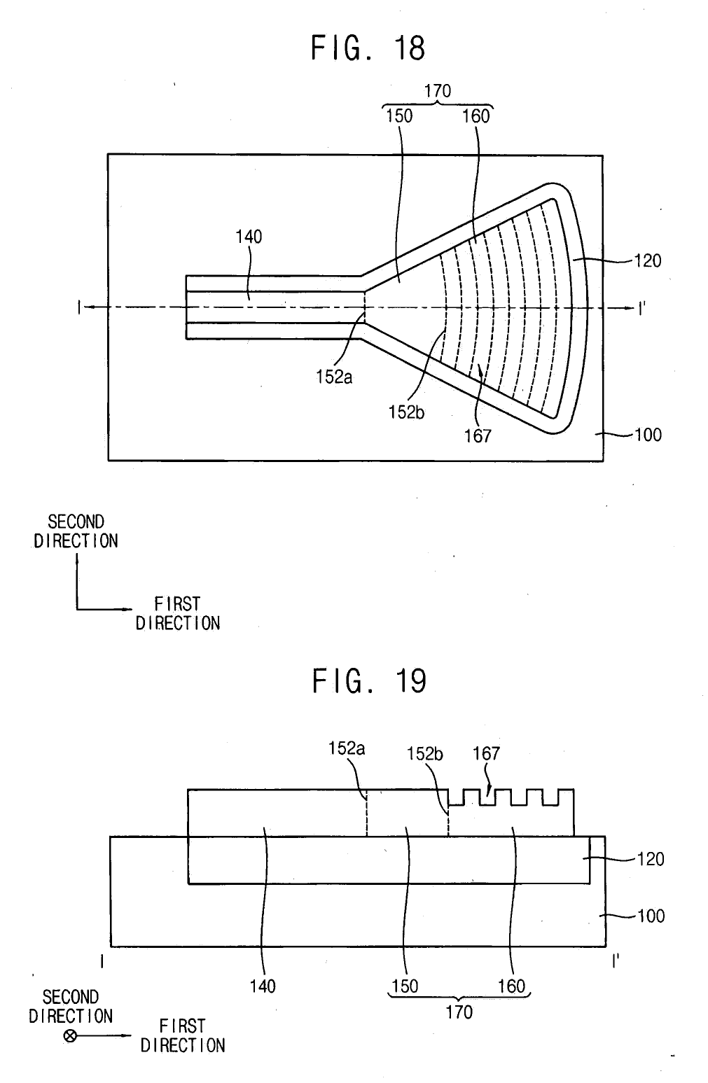

Referring to FIGS. 18 and 19, a top surface of the second portion of the crystalline semiconductor layer pattern 135 may be partially etched to form a plurality of first grooves 167 in the second direction.

In example embodiments, the first grooves 167 may be formed by a dry etching process using a third photoresist pattern (not shown) as an etching mask.

In example embodiments, the first grooves 167 may be formed to have a shape of a portion of concentric circles, e.g., an arc shape, and the second center point C2 (refer to FIG. 1), which may be the center of the concentric circles, may be located at a position farther from the second portion of the crystalline semiconductor layer pattern 135 than the first center point C1 (refer to FIG. 1) at an interface between the first and second portions of the crystalline semiconductor layer pattern 135. That is, the first curvature radius R1 defined by a distance from each of the first grooves 167 to the second center point C2 may be greater than the distance D from each of the first grooves 167 to the first center point C1.

Accordingly, the first portion of the crystalline semiconductor layer pattern 135 may serve as a first optical waveguide 140. Additionally, a portion of the second portion of the crystalline semiconductor layer pattern 135, which may be close to the first optical waveguide 140 and does not have the first grooves thereon, may serve as a first taper portion 150, and a portion of the second portion of the crystalline semiconductor layer pattern 135, which may have the first grooves 167 thereon, may serve as a first grating portion 160.

By the above processes, the first optical coupling system may be manufactured. The third and fourth optical coupling systems in accordance with example embodiments may be also manufactured by performing processes substantially the same as or similar to those illustrated with reference to FIGS. 10 to 19.

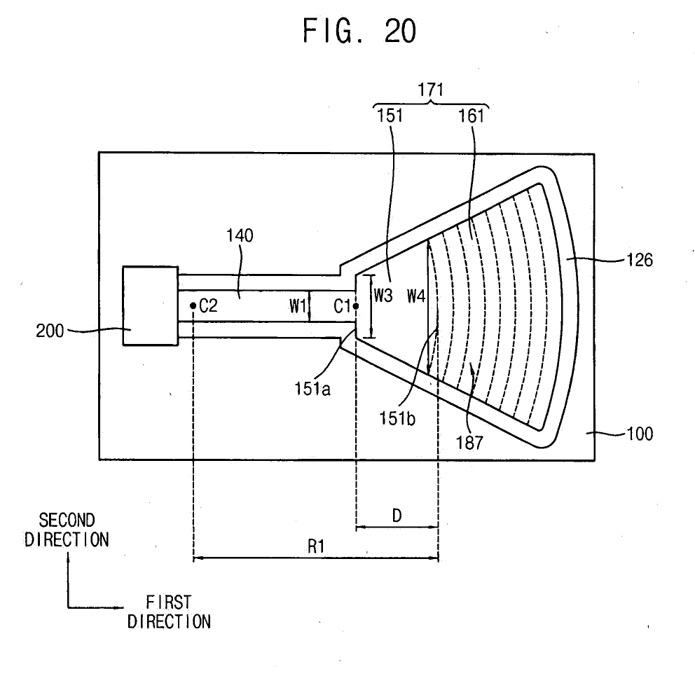

FIG. 20 is a plan view illustrating a fifth optical coupling system in accordance with example embodiments. The fifth optical coupling system may be substantially the same as or similar to the first optical coupling system, except for the shapes of the optical coupler, e.g., the tapered portion, and the corresponding cladding. Thus, like reference numerals refer to like elements, and detailed descriptions thereon may be omitted below in the interest of brevity.

Referring to FIG. 20, the fifth optical coupling system may include the first optical waveguide 140 and a fifth optical coupler 171 on the first substrate 100.

The fifth optical coupler 171 may include a fifth tapered portion 151 and a fifth grating portion 161.

The fifth tapered portion 151 may be connected to the first optical waveguide 140 at a first end 151a thereof in the first direction. In example embodiments, the fifth tapered portion 151 may have a fan-like shape, and a width thereof in the second direction may increase along the first direction.

In example embodiments, the fifth tapered portion 151 may have a third width W3 in the second direction, which may be greater than the first width W1 of the first optical waveguide 140 in the second direction, at the first end 151a, and may have a fourth width W4 in the second direction, which may be greater than the third width W3, at a second end 151b opposed to the first end 151a in the first direction. The first end 151a of the fifth tapered portion 151 may have a linear bar shape extending in the second direction, and the second end 151b of the fifth tapered portion 151 may have a shape of a portion of a circle, i.e., an arc shape. The arc shape of the second end 151b of the fifth tapered portion 151 may be substantially the same as that of fifth grooves 187 of the fifth grating portion 161.

The fifth grating portion 161 may be connected to the second end 151b of the fifth tapered portion 151. In example embodiments, the fifth grating portion 161 may have a fan-like shape, and a width thereof in the second direction may increase along the first direction. Thus, a first end of the fifth grating portion 161 connected to the fifth tapered portion 151 may have the fourth width W4 in the second direction, which may be the same as that of the second end 151b of the fifth tapered portion 151, and a second end of the fifth grating portion 161 opposed to the first end thereof in the first direction may have a width greater than the fourth width W4.

The fifth grating portion 161 may include a plurality of fifth grooves 187 in the second direction thereon. In example embodiments, each of the fifth grooves 187 may have a shape of a portion of concentric circles, i.e., an arc shape, and a center of the concentric circles may be located on a line passing a first center point C1, which is a center point of the first end 151a of the fifth tapered portion 151 in the second direction, and extending in the first direction. Hereinafter, the center of the concentric circles may be referred to as a second center point C2. In example embodiments, the second center point C2 may be located in the first optical waveguide 140 or in the light source 200. Alternatively, the second center point C2 may be located on the first substrate 100 away from the light source 200, or at other positions away from the first substrate 100.

A distance from each of the fifth grooves 187 to the second center point C2 may be referred to as a first curvature radius R1, which may be greater than a distance D from each of the fifth grooves 187 to the first end 151a of the fifth tapered portion 151, i.e., a distance from each of the fifth grooves 187 to the first optical waveguide 140. In an example embodiment, the first curvature radius R1 may be equal to or more than about three times of the distance D.

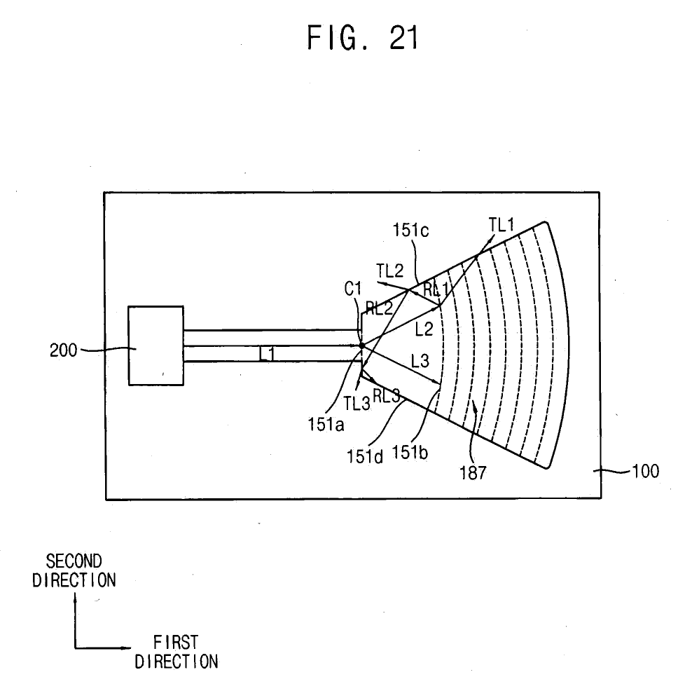

FIG. 21 illustrates an optical path in the fifth optical coupling system in accordance with example embodiments.

Referring to FIG. 21, a light signal generated and emitted from the light source 200, e.g., a first laser beam L1 may be guided by the first optical waveguide 140 into the first direction to enter the fifth optical coupler 171. The first laser beam L1 may be divided into a plurality of laser beams in the fifth tapered portion 151 of the fifth optical coupler 171, and second and third laser beams L2 and L3 among the plurality of laser beams are illustrated in FIG. 21.

For the convenience of explanation, only the second laser beam L2 will be explained hereinafter. A portion of the second laser beam L2, which may start from the first center point C1 located at a center of the first end 151a of the fifth tapered portion 151 in the second direction to enter the fifth grating portion 161, may penetrate through the fifth grating portion 161 by diffraction to be emitted toward an outside as a first penetration beam TL1, and another portion of the second laser beam L2 may be reflected at the second end 151b of the fifth tapered portion 151 to become a first reflection beam RL1.

The second center point C2, which may be a center of concentric circles formed by the fifth grooves 187 of the fifth grating portion 161, may be located at a position different from that of the first center point C1, and thus not all of the first reflection beam RL1 may be reflected toward the first center C1 according to the law of reflection, and at least a portion of the first reflection beam RL1 may be reflected toward a third end 151c of the fifth tapered portion 151 in the second direction.

A portion of the first reflection beam RL1 reflected toward the third end 151c of the fifth tapered portion 151 may penetrate through the third end 151c of the fifth tapered portion 151 toward an outside to become a second penetration beam TL2, and at least a portion of the first reflection beam RL1 may be reflected toward the first end 151a of the fifth tapered portion 151 to become a second reflection beam RL2. A portion of the second reflection beam RL2 may be reflected from the first end 151a of the fifth tapered portion 151 toward a fourth end 151d of the fifth tapered portion 151 opposed to the third end 151c in the second direction to become a third reflection beam RL3, while a portion of the second reflection beam RL2 may penetrate through the first end 151a of the fifth tapered portion 151 toward an outside to become a third penetration beam TL3.

That is, in the first optical coupling system, most of the second reflection beam RL2 may be reflected at the third end 150c of the first tapered portion 150 to re-enter the first optical waveguide 140, while in the fifth optical coupling system, at least a portion of the second reflection beam RL2 may be reflected toward the first end 151a of the fifth tapered portion 151 to penetrate through the fifth tapered portion 151 toward the outside, which may reduce the rate of re-entering into the first optical waveguide 140. Thus, the fifth optical coupling system and the light source 200 may have good characteristics and efficiency not deteriorated by reflection.

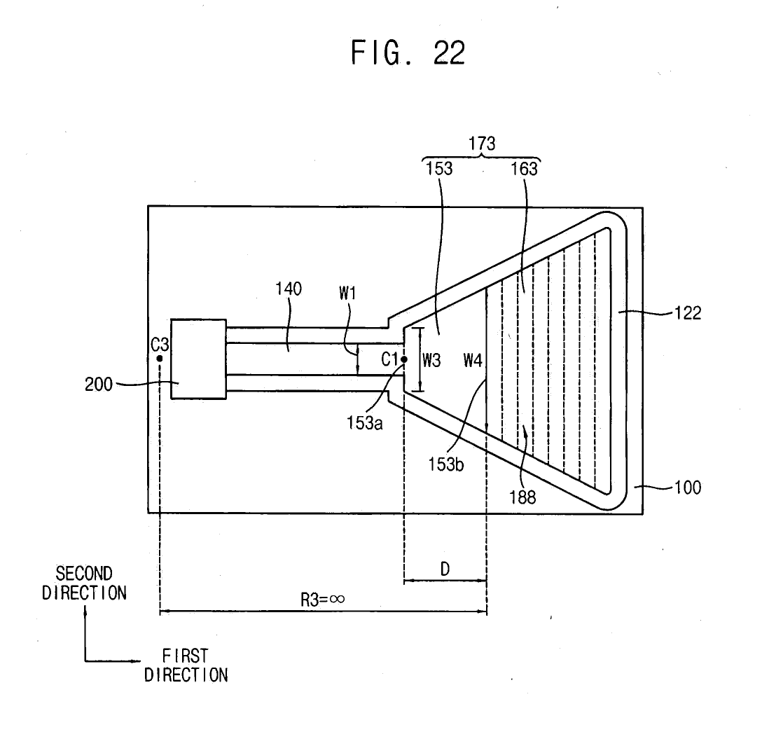

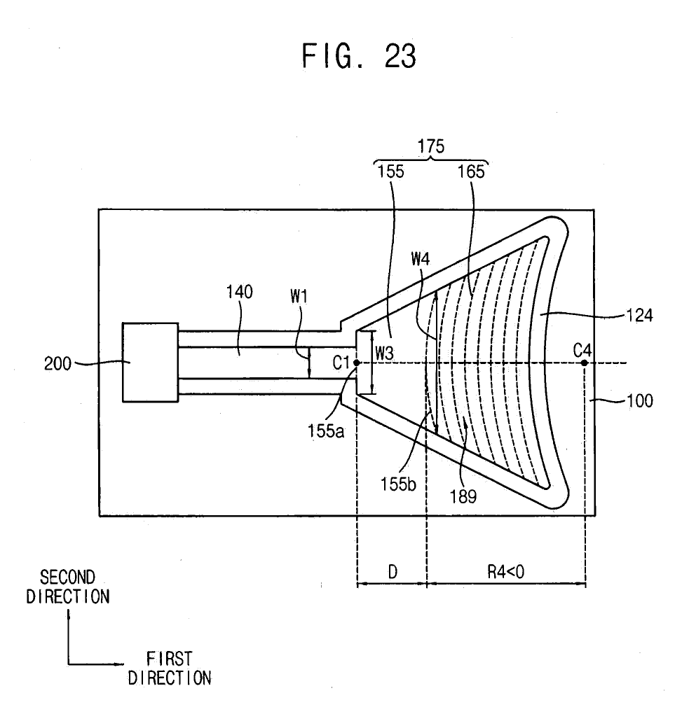

FIGS. 22 and 23 are plan views illustrating sixth and seventh optical coupling systems in accordance with example embodiments. The sixth and seventh optical coupling systems may be substantially the same as the third and fourth optical coupling systems illustrated with reference to FIGS. 6 and 7, respectively, except for the shapes of the optical coupler, e.g., the tapered portion, and the corresponding cladding. Thus, like reference numerals refer to like elements, and detailed descriptions thereon are omitted herein.

Referring to FIG. 22, the sixth optical coupling system may include the first optical waveguide 140 and a sixth optical coupler 173 on the first substrate 100.

The sixth optical coupler 173 may include a sixth tapered portion 153 and a sixth grating portion 163.

The sixth tapered portion 153 may be connected to the first optical waveguide 140 at a first end 153a thereof in the first direction. In example embodiments, the sixth tapered portion 153 may have a fan-like shape, and a width thereof in the second direction may increase along the first direction.

In example embodiments, the sixth tapered portion 153 may have a third width W3 in the second direction, which may be greater than the first width W1 of the first optical waveguide 140 in the second direction, at the first end 153a, and may have the fourth width W4 in the second direction, which may be greater than the third width W3, at a second end 153b opposed to the first end 153a in the first direction. Each of the first and second ends 153a and 153b of the sixth tapered portion 153 may have a linear bar shape extending in the second direction.

According to the result of experiment, in the sixth optical coupling system, a rate of re-entering into the light source 200 of a light, which may be emitted from the light source 200 to be reflected by the sixth optical coupler 173, was less than about 0.1%.

Referring to FIG. 23, the seventh optical coupling system may include the first optical waveguide 140 and a seventh optical coupler 175 on the first substrate 100.

The seventh optical coupler 175 may include a seventh tapered portion 155 and a seventh grating portion 165.

The seventh tapered portion 155 may be connected to the first optical waveguide 140 at a first end 155a thereof in the first direction. In example embodiments, the seventh tapered portion 155 may have a fan-like shape, and a width thereof in the second direction may increase along the first direction.

In example embodiments, the seventh tapered portion 155 may have a third width W3 in the second direction, which may be greater than the first width W1 of the first optical waveguide 140 in the second direction, at the first end 155a, and may have the fourth width W4 in the second direction, which may be greater than the third width W3, at a second end 155b opposed to the first end 155a in the first direction. The first end 155a of the seventh tapered portion 155 may have a linear bar shape extending in the second direction, and the second end 155b of the seventh tapered portion 155 may have a shape of a portion of a circle, i.e., an arc shape convex toward the first end 155a of the seventh tapered portion 155.

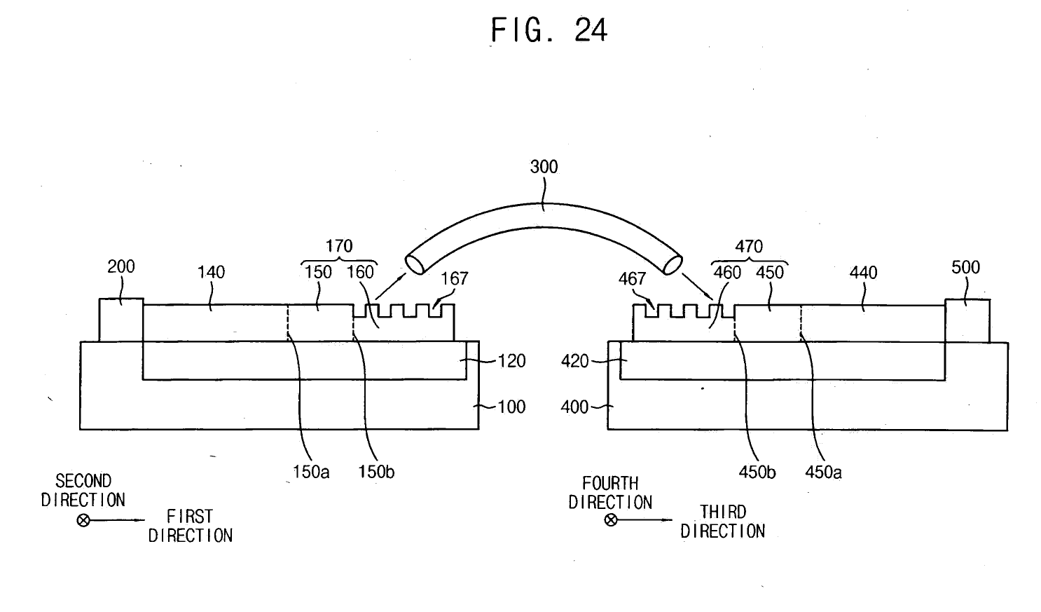

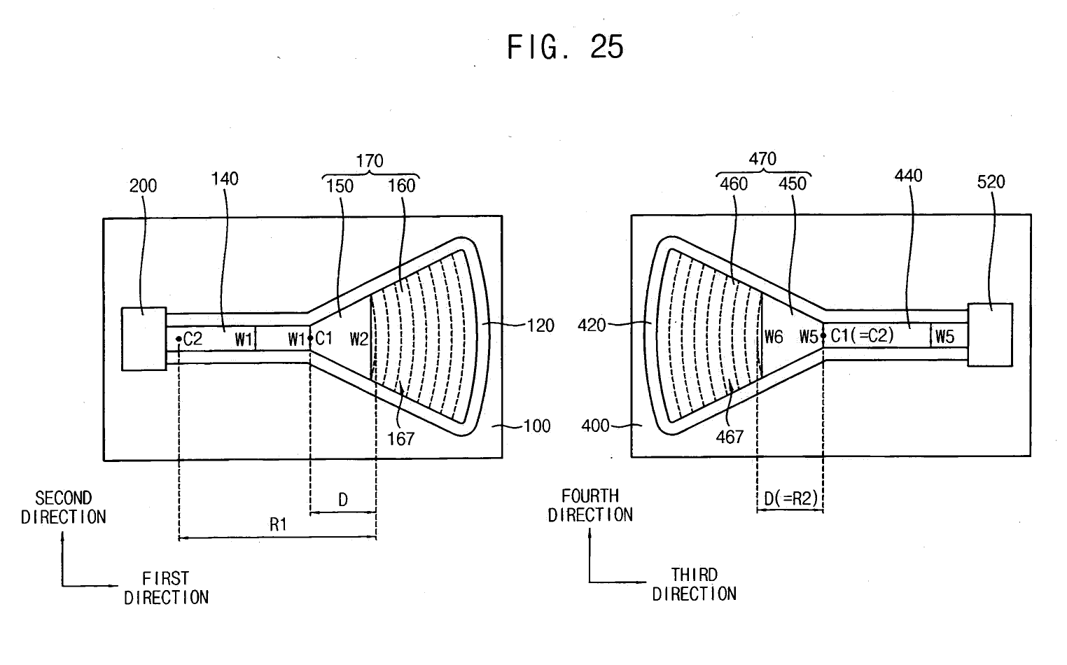

FIGS. 24 and 25 illustrate an optical system in accordance with example embodiments. FIG. 24 includes a cross-sectional view of structures on each substrate, and FIG. 25 includes a plan view of the structures on each substrate.

Referring to FIGS. 24 and 25, the optical system may include the light source 200, the first optical waveguide 140, the first optical coupler 170, an optical fiber 300, an eighth optical coupler 470, and a light receiving element 500. The optical system may further include a second optical waveguide 440.

The light source 200 may be formed on the first substrate 100, and may emit a light signal, e.g., a laser beam.

The first waveguide 140 may be formed on the first substrate 100, and may be connected to the light source 200. The first waveguide 140 may guide the light signal emitted from the light source 200. In example embodiments, the first waveguide 140 may extend in a first direction substantially parallel to a top surface of the first substrate 100, and may have a first width W1 in a second direction substantially parallel to the top surface of the first substrate 100 and substantially perpendicular to the first direction.

The first optical coupler 170 may be formed on the first substrate 100 to be connected to the first optical waveguide 140, and may emit the light signal guided by the first optical waveguide 140 toward an outside. Accordingly, the first optical coupler 170 may be referred to as an output optical coupler. In example embodiments, the first optical coupler 170 may have a fan-like shape.

The first optical coupler 170 may include the first tapered portion 150 and the first grating portion 160. The first tapered portion 150 may have the first width W1 in the second direction at the first end 150a thereof connected to the first optical waveguide 140, and may have the second width W2 in the second direction greater than the first width W1 at the second end 150b thereof opposed to the first end 150a in the first direction. The first grating portion 160 may be connected to the second end 150b of the first tapered portion 150, and may include a plurality of first grooves 167 in the second direction thereon. Each of the first grooves 167 may have a shape of a portion of concentric circles, i.e., an arc shape, and each of the concentric circles may have the first curvature radius R1 greater than the distance D from each of the first grooves 167 to the first optical waveguide 140.

The optical fiber 300 may transfer the light signal output from the first optical coupler 170 to the eighth optical coupler 470 on a second substrate 400.

The eighth optical coupler 470 may be formed on the second substrate 400, and may be connected to the second optical waveguide 440. The light signal transferred by the optical fiber 300 may be input into the eighth optical coupler 470. Accordingly, the eighth optical coupler 470 may be referred to as an input optical coupler. The second optical waveguide 440 may be formed on the second substrate 400, and may extend in a third direction substantially parallel to a top surface of the second substrate 400. The second optical waveguide 440 may have a fifth width W5 in a fourth direction substantially parallel to the top surface of the second substrate 400 and substantially perpendicular to the third direction.

The eighth optical coupler 470 may include the eighth tapered portion 450 and the eighth grating portion 460. In example embodiments, the eighth optical coupler 470 may have a fan-like shape.

The eighth tapered portion 450 may have a fifth width W5 in the fourth direction at a first end 450a thereof connected to the second optical waveguide 440, and may have a sixth width W6 in the fourth direction greater than the fifth width W5 at a second end 450b thereof opposed to the first end 450a in the third direction. The eighth grating portion 460 may be connected to the second end 450b of the eighth tapered portion 450, and may include a plurality of eighth grooves 467 in the third direction thereon. Each of the eighth grooves 467 may have a shape of a portion of concentric circles, i.e., an arc shape, and each of the concentric circles may have a second curvature radius R2 substantially the same as a distance D from each of the eighth grooves 467 to the second optical waveguide 440.

The light receiving element 500 may be formed on the second substrate 400, and may receive the light signal having passed the second optical waveguide 440 to convert it into an electrical signal. In example embodiments, the light receiving element 500 may include a photo diode (PD).

In the optical system, the output and input optical couplers 170 and 470 having the fan-like shape on the first and second substrate 100 and 400, respectively, may have the different first and second curvature radii R1 and R2, respectively. Particularly, the input optical coupler 470 may have the second curvature radius R2 substantially the same as the distance D to the second optical waveguide 440, and thus may transfer most of the light signal input into the input optical coupler 470 to the second optical waveguide 440. The output optical coupler 170 may have the first curvature R1 greater than the distance D to the first waveguide 140, and thus only a very small portion of the light signal emitted from the light source 200 may be reflected to the first optical waveguide 140 at the output optical coupler 170. Accordingly, a rate of re-entering into the light source 200 of light through the first optical waveguide 140 may be very small, and thus the characteristics and efficiency of the light source 200 may not be deteriorated.

FIGS. 24 and 25 show only the first optical coupler 170 included in the first optical coupling system as the output optical coupler, however, the third to seventh optical couplers 172, 174, 171, 173 and 175 may also serve as the output optical coupler.

The foregoing is illustrative of example embodiments and is not to be construed as limiting thereof Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. In the claims, means-plus-function clauses are intended to cover the structures described herein as performing the recited function and not only structural equivalents but also equivalent structures. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. An optical coupler, comprising:
a tapered portion having opposite first and second ends, wherein a width of the tapered portion increases from the first end to the second end; and
a grating portion connected to the second end of the tapered portion, the grating portion having a curvature radius greater than a distance to the first end of the tapered portion.

2. The optical coupler of claim 1, wherein the curvature radius of the grating portion is at least about three times the distance to the first end of the tapered portion.

3. The optical coupler of claim 1, wherein the curvature radius of the grating portion is infinite.

4. The optical coupler of claim 1, wherein the grating portion is concave toward the first end of the tapered portion.

5. The optical coupler of claim 1, wherein the grating portion is convex toward the first end of the tapered portion.

6. An optical coupling system, comprising:
an optical coupler on a substrate, the optical coupler comprising:
a tapered portion having opposite first and second ends, wherein a width of the tapered portion increases from the first end to the second end; and
a grating portion connected to the second end of the tapered portion, the grating portion having a curvature radius greater than a distance to the first end of the tapered portion; and
an optical waveguide connected to the first end of the tapered portion.

7. The optical coupling system of claim 6, wherein the tapered portion defines a first direction, and wherein the optical waveguide extends in the first direction.

8. The optical coupling system of claim 7, wherein the optical waveguide comprises opposite first and second ends, wherein the optical waveguide second end is connected to the first end of the tapered portion, and wherein a light source configured to emit a light signal is located at the optical waveguide first end.

9. The optical coupling system of claim 6, wherein the first end of the tapered portion has a width that is substantially the same as that of the optical waveguide.

10. The optical coupling system of claim 6, wherein the first end of the tapered portion has a width greater than that of the optical waveguide.

11. The optical coupling system of claim 6, wherein the curvature radius of the grating portion is at least about three times the distance to the first end of the tapered portion.

12. The optical coupling system of claim 6, wherein the curvature radius of the grating portion is infinite.

13. The optical coupling system of claim 6, wherein the grating portion is concave toward the first end of the tapered portion.

14. The optical coupling system of claim 6, wherein the grating portion is convex toward the first end of the tapered portion.

15. The optical coupling system of claim 6, further comprising a cladding between the substrate and the optical coupler and between the substrate and the optical waveguide.

16. An optical coupling system, comprising:
an optical coupler, comprising:
a tapered portion having opposite first and second ends, wherein a width of the tapered portion increases from the first end to the second end; and
a grating portion connected to the second end of the tapered portion, the grating portion comprising a plurality of grooves, each groove having a curvature radius that is greater than a distance from the respective groove to the first end of the tapered portion; and
an optical waveguide connected to the first end of the tapered portion.

17. The optical coupling system of claim 16, wherein the plurality of grooves are concave toward the tapered portion first end.

18. The optical coupling system of claim 16, wherein the plurality of grooves are convex toward the tapered portion first end.

19. The optical coupling system of claim 16, wherein the first end of the tapered portion has a width that is substantially the same or greater than a width of the optical waveguide.

20. The optical coupling system of claim 16, wherein the optical waveguide comprises opposite first and second ends, wherein the optical waveguide second end is connected to the first end of the tapered portion, and further comprising a light source configured to emit a light signal located at the optical waveguide first end.
